(19) United States
(12) Patent Application Publication
(10) Pub. No.: US 2012/0013919 A1
(43) Pub. Date: Jan. 19, 2012

(54) Label Printing

(76) Inventors: Brian L. Helterline, Salem, OR (US); Edward T. Bedfod, Corvallis, OR (US)

(21) Appl. No.: 13/259,413

(22) PCT Filed: Jan. 28, 2010
(86) PCT No.: PCT/US10/22412

§ 371 Date: Sep. 23, 2011

(51) Int. Cl. G06K 15/02

(52) U.S. Cl. 358/1.6; 358/1.5

(57) ABSTRACT

Method of label printing, using media comprising a number of labels and a printhead comprising a leading and a trailing slot, comprising starting a movement of the media with respect to the printhead until the media reaches a certain continuous velocity with respect to the printhead, ejecting fluid onto a label near a first edge of a label from the trailing slot and not from the leading slot, and ejecting fluid onto the label near a second edge of the label, opposite said first edge, from the leading slot and not from the trailing slot.

### BACKGROUND OF THE INVENTION

Before printing a label on a continuous roll, the media is typically positioned with respect to the printhead such that printing can begin at the top of the label. To obtain a margin-less quality print, the slot of the printhead is positioned at a short distance away from the top of the label. This allows the media to come up to speed with respect to the printhead before printing begins at the top of the label. When the media is brought up to speed, the printhead prints the entire label between a top and bottom edge without margins and at a continuous velocity. Maintaining the continuous velocity may prevent ink ramps being formed on the label when the media accelerates or decelerates. When the printing of the label is completed, the media will slow down with respect to the print head. While slowing down, the slot may pass the gap between two subsequent labels. Usually, the slot even passes by the top of the next label. The drive mechanism will then have to back up the media after the label is printed. This allows the media to come up to speed again before printing the next label.

Printing while the drive mechanism is still gaining speed or is slowing down would cause ink ramp formation on the media. Current drive mechanisms are therefore arranged to drive the media in two moving directions. A problem of this process is that the backup movement causes a delay between printing two subsequent labels.

### BRIEF DESCRIPTION OF THE DRAWINGS

For the purpose of illustration, certain embodiments of the present invention will now be described with reference to the accompanying diagrammatic drawings, in which:

FIG. 1 shows a diagram of a side view of a label print arrangement and a label receiving object;

FIG. 2 shows a diagrammatic side view of a printhead and media in a start and/or stop position;

FIG. 2A shows a detail of FIG. 2 in an enlarged view;

FIG. 3 shows a diagrammatic side view of the printhead and media, wherein a first portion near a first edge of a label is indicated that is printed by a trailing slot and not by a leading slot, and the printhead is shown in a position just before printing said first portion with the trailing slot;

FIG. 4 shows a diagrammatic side view of the printhead and media, wherein a middle portion of the label is indicated that is printed by both the trailing and the leading slot, and the printhead is shown in a position right after both the leading and the trailing slot have printed the middle portion;

FIG. 5 shows a diagrammatic side view of the printhead and media, wherein a second portion near a second edge of the label is indicated that is printed by the leading slot and not by the trailing slot, and the printhead is shown in a position right after the leading slot has printed the second portion;

FIG. 6 shows a flowchart of a method of label printing; and

FIG. 7 illustrates instructions for enacting the method of label printing of FIG. 6.

### DETAILED DESCRIPTION

In the following detailed description, reference is made to the accompanying drawings. The embodiments in the description and drawings should be considered illustrative and are not to be considered as limiting to the specific embodiment of element described. Multiple embodiments may be derived from the following description and/or drawings through modification, combination or variation of certain elements. Furthermore, it may be understood that also embodiments or elements that are not literally disclosed may be derived from the description and drawings by a person skilled in the art.

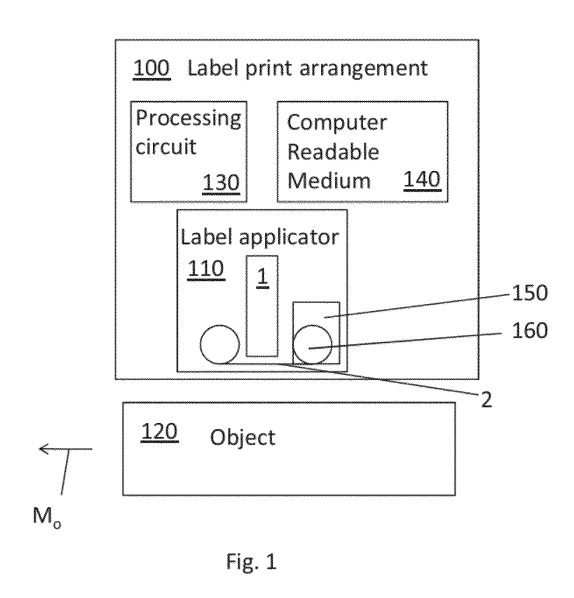

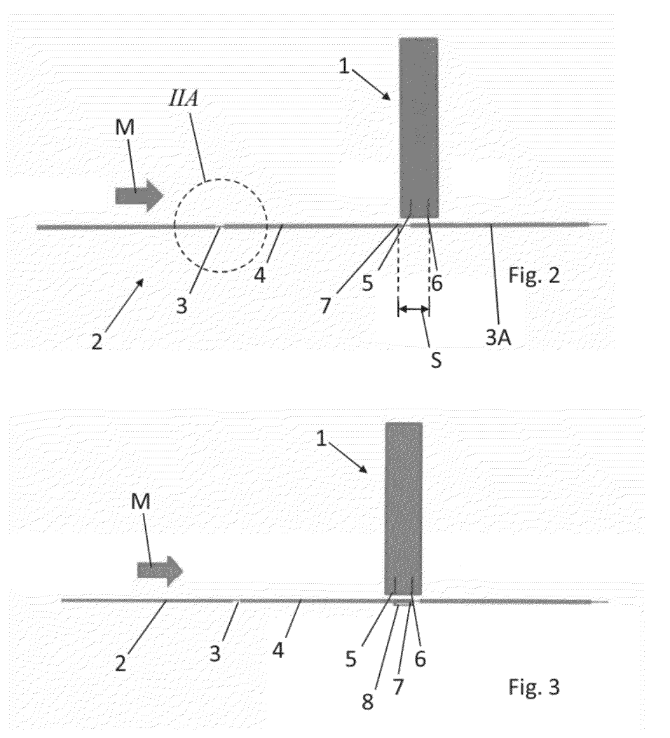

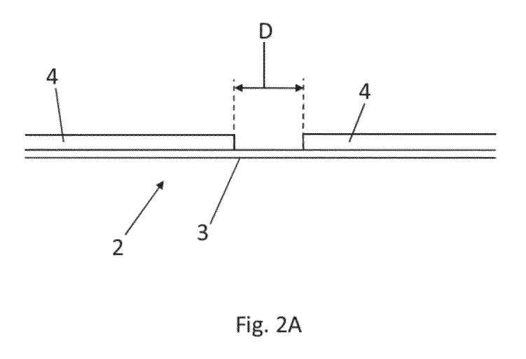

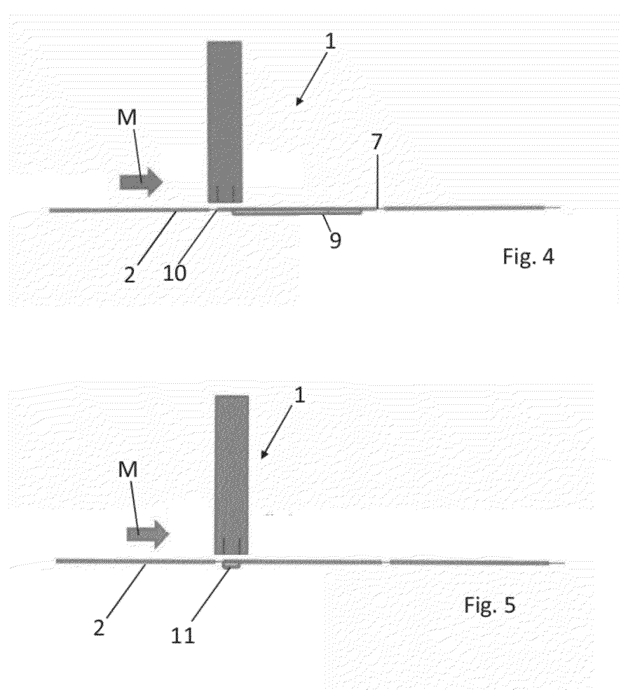

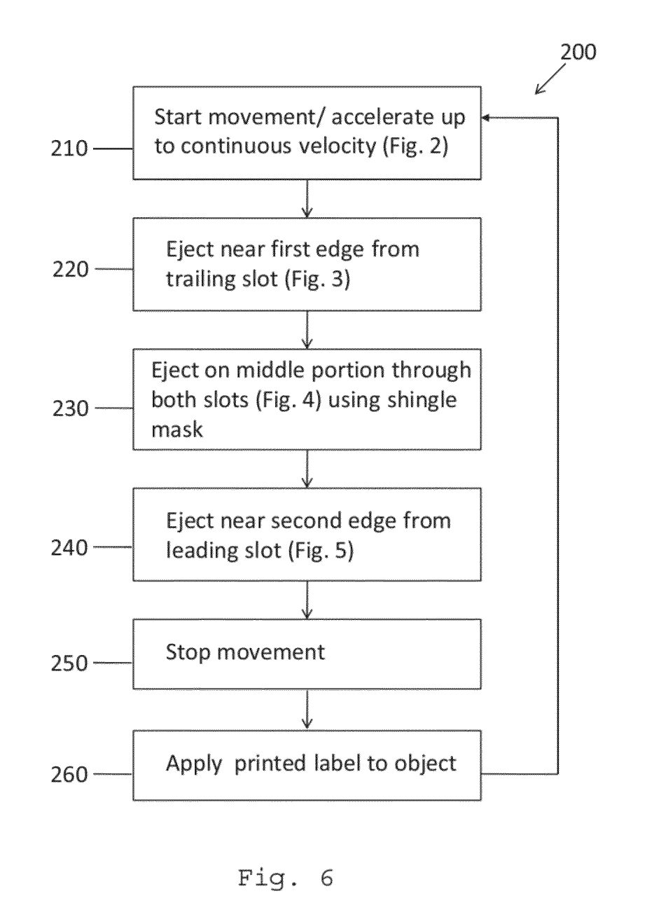

FIG. 1 shows a label print arrangement 100. The label print arrangement 100 may comprise a label applicator 110 arranged to apply a label 4 to an object 120 by bringing it in contact with the object 120. The label 4 may self adhere. Optionally, the label applicator 110 may move and adhere the label 4 to the object 120 in any known manner. The label print arrangement 100 may comprise a print head 1, provided with a leading and a trailing slot 5, 6, as shown in FIG. 2-5, for printing the labels 4. The object 120 may move with respect to the print head 1 in a direction Mₒ.

A label roll 160 provided with labels 4 may be mounted onto the label print arrangement 100. The arrangement 100 may further comprise a label roll drive arrangement 150 for driving the label roll 160, and optionally for mounting the label roll 160. The label roll drive arrangement 150 may be arranged to start and stop the movement of the label roll 160 with respect to the print head 1.

The label print arrangement 100 may comprise a computer readable medium 140. The computer readable medium 140 may comprise an internal or external digital storage arrangement, such as a internal and/or external non-volatile memory. The computer readable medium 140 may store a list of instructions configured to signal components of the arrangement 100 to perform a series of actions as described below. The label print arrangement 100 may further comprise a processing circuit 130 to execute the instructions. The computer readable medium 140 and the processing circuit 130 may be part of the label print arrangement 100, and/or part of a computer connected to the label print arrangement 100.

In an embodiment, the label print arrangement 100 may comprise a dedicated label print arrangement 100 dedicated to printing labels 4. In other embodiments, the label print arrangement 100 may comprise any printer with a label print application, for example comprising label print software and/or hardware. The label print arrangement 100 may comprise an inkjet print head 1.

FIG. 2-5 diagrammatically show a printhead 1 and media for a label print arrangement 100. An enlarged view of a section of the label sheet 2 of FIG. 2-5 is shown in FIG. 2A. The label print arrangement 100 may be arranged to sequentially print the labels 4, and a label applicator 110 may be provided for sequentially applying the printed labels 4 to objects 120. In this embodiment the media comprises a label sheet 2. The label sheet 2 may be part of a label roll 160. The label sheet 2 may comprise a back sheet 3 and multiple labels 4. The labels 4 may comprise adhesive for being applied to an object 120 such as a product, carton, box or paper.

The printhead 1 may be provided with a leading 5 and a trailing slot 6 for ejecting fluid onto a label 4 in predetermined patterns. The fluid may comprise any suitable printing fluid such as ink. In this context, the leading slot 5 may be the front running slot with respect to the moving label sheet 2. Accordingly, a label 4 may first pass by the leading slot 5 and second by the trailing slot 6. The slots 5, 6 may comprise nozzles or rows of nozzles that are arranged behind each other in a direction of label motion M. The print head 1 may comprise at least one leading slot row and at least one trailing slot row. The print head may comprise more than two rows, and/or multiple leading slot rows and/or multiple trailing slot rows. The direction M of label sheet motion with respect to the printhead 1 is shown in FIG. 2-5. In the discussed embodiment, the labels 4 are moved with respect to the printhead 1. In another embodiment, the printhead 1 is moved with respect to the labels 4. In again another embodiment, both may move with respect to each other.

The label print arrangement 100 may be provided with a label roll drive arrangement 150, such as for example an electromotor. The label roll drive arrangement 150 may drive the label roll 160 so that the labels 4 move with respect to the printhead 1. In an embodiment, the drive arrangement 150 may be arranged to drive in a single drive direction so that the labels 4 may move in the label sheet motion direction M only. The label roll drive arrangement 150 may be arranged to start and stop the movement of the label sheet 2 with respect to the printhead 1. This may allow printing of a first label 4, movement of the first label 4 away from the printhead 1 and/or applying said first label 4 to an object 120, positioning a second label 4 with respect to the printhead 1 for printing, printing the second label 4, moving and/or applying the second label 4, and similarly applying further labels 4.

For example, FIG. 2 shows the printhead 1 in an end position with respect to a previously printed label 4. When starting up the label sheet 2, the label sheet 2 may need a certain distance S to reach a continuous velocity with respect to the printhead 1. For example, in practice an electromotor needs a couple of turns before it runs at the continuous velocity. In the shown end position, the leading slot 5 may have just passed the edge of a first label 4.

FIG. 3 may show the position wherein the label sheet 2 has reached the final, continuous velocity with respect to the printhead 1. In this position, there is already some margin between the leading slot 5 and a first edge 7 of the respective label 4. However, the trailing slot 6 may be positioned near the first edge 7 of the label 4 so that by printing from said trailing slot 6 substantially marginless printing may be achieved. When the trailing slot 6 has reached or passed the first edge 7, the final velocity may already have been reached, for example so that ink ramp formation may be prevented, and substantially marginless printing may be achieved. After reaching said continuous velocity, fluid may be ejected from the trailing slot 6 only onto the first portion 8 near the first edge 7 of the label 4. This may allow the fluid to be disposed onto the label 4 near the first edge 7. Said first portion 8 may extend over a distance in a moving direction M that is approximately the same or less as the distance between the leading and the trailing slot 5, 6. The exemplary moving direction M shown in FIGS. 2-5 is the moving direction of the media with respect to the print head 1.

In one embodiment, the trailing slot 6 may start printing while the leading slot 5 does not print. Afterwards the fluid may be distributed over both the leading and the trailing slot 5, for example using shingle mask techniques. In a further embodiment, the trailing slot 6 may start printing while the drive arrangement 150 is still gaining speed. In another embodiment, both the trailing slot 6 and the leading slot 5 may start printing at the same time, for example using shingle mask techniques for distributing the fluid, wherein the first portion 8 is printed by the trailing slot 6 only.

The label 3 may comprise a first portion 8, a middle portion 9 and a second portion 11. The fluid may be ejected onto the middle portion 9 of the label 4 by both the leading and the trailing slot 5, 6. The fluid may be distributed to both the leading and the trailing slot 5, 6 at the same time, and ejected onto the middle portion 9 of the label 4 through both slots. In FIG. 4 the printhead 1 is shown after having printed the middle portion 9 of the label 4. The middle portion 9 may be defined as the portion of the label 4 that is printed by both slots 5, 6. The label sheet 2 may move at a substantially continuous velocity with respect to the printhead 1 when the middle portion 9 of the label 4 is printed.

Opposite the first edge 7 the label 4 may comprise a second edge 10. A second portion 11 may be provided between the middle portion 9 and the second edge 10, as shown by FIG. 5. Fluid may be ejected onto the second portion 11 near the second edge 10 from the leading slot 5 and not from the trailing slot 6. Passed or near the second edge 10, printing may stop and the label sheet 2 may slow down with respect to the printhead 1. Optionally, slowing down may start while the leading slot 5 is still printing the second portion 11. Optionally, the trailing slot 6 may stop printing before the leading slot 5. The width of the second portion 11 may be approximately the same as the distance between the slots 5, 6. When the label sheet 2 finally stops with respect to the printhead 1, the leading slot 5 may have passed the second edge 10, and optionally the first edge 7 of a next label 4. Then, the printhead 1 and the label sheet 2 may be arranged in an end position as shown in FIG. 2.

In one embodiment, the trailing slot 6 may print when the label sheet 2 is still starting up, and/or the leading slot 5 may print when the label sheet 2 is still slowing down with respect to the printhead 1. At the middle portion 10, shingle masking may be applied to distribute the fluid to the leading and trailing slots 5, 6. A shingle mask may be defined as a set of instructions for directing fluid ejection through respective slots. For example, shingle masking may be applied in known large format printing processes, to distribute print fluid over multiple overlapping passes to even out nozzle usage, hide defects and improve print quality. However, in this embodiment, shingle masking may be used to advantage in a label print arrangement 100 to distribute the fluid to both slots 5, 6 when printing the middle portion 9. The shingle mask instructions may be stored in the computer readable medium 140, such as an internal or external storage unit, for example a non-volatile memory, in the print arrangement and may be executed by the processing circuit 130 of the print arrangement. The processing circuit 130 may instruct the print head 1 to print the first portion 8 by the trailing slot 6, print the middle portion 9 by both slots 5, 6 using shingle masking algorithms, and print the second portion 11 by the leading lot 5.

The label roll drive arrangement 150 may be configured to drive the label roll 160 in one direction. Because of above explained usage of the leading and trailing slot 5, 6 it may be prevented to reposition the printhead 1 between printing two subsequent labels 4, and hence, in a particular embodiment, a one direction only drive arrangement 150 may be applied. This may provide for a relatively time and cost efficient label printing. For example, the drive arrangement 150 may comprise an electromotor.

The distance D (see FIG. 2A) between the slots 5, 6 may be at least approximately 0.05 inch (approximately 0.1 centimeter), or at least approximately 0.2 inch, for example approximately 0.46 inch (approximately 1.2 centimeter). This may be enough distance for allowing the printhead 1 and the media 2 to reach the continuous velocity with respect to each other while preventing ramp formation by selectively using the leading and/or the trailing slot 5, 6. In an embodiment, the drive arrangement 150 may be arranged so that the label sheet 2 may reach said continuous velocity in approximately 0.5 inch (approximately 1.3 centimeter) or less, for example approximately 0.4 inch (approximately 1 centimeter) or less. The distance between two labels 4 on the label sheet 2 may for example be approximately 0.125 inch (approximately 0.3 centimeter).

The label print arrangement 100 may advantageously comprise a relatively simple printhead, for example arranged to print in one color only, for example substantially black ink or the like for printing substantially black ink on labels 3. The fluid ejected through both slots 5, 6 may comprise the same colored fluid. The label print arrangement 100 may comprise a label applicator 110, arranged to apply a first label 4 to an object 120 between printing the first label 4 and the second label 4. Since the label 4 does not have to be repositioned after each print, the label print and label application velocity may be increased with respect to conventional processes. In other embodiments, the label print arrangement 100 may comprise a multicolored printer, comprising multiple inks of different colors.

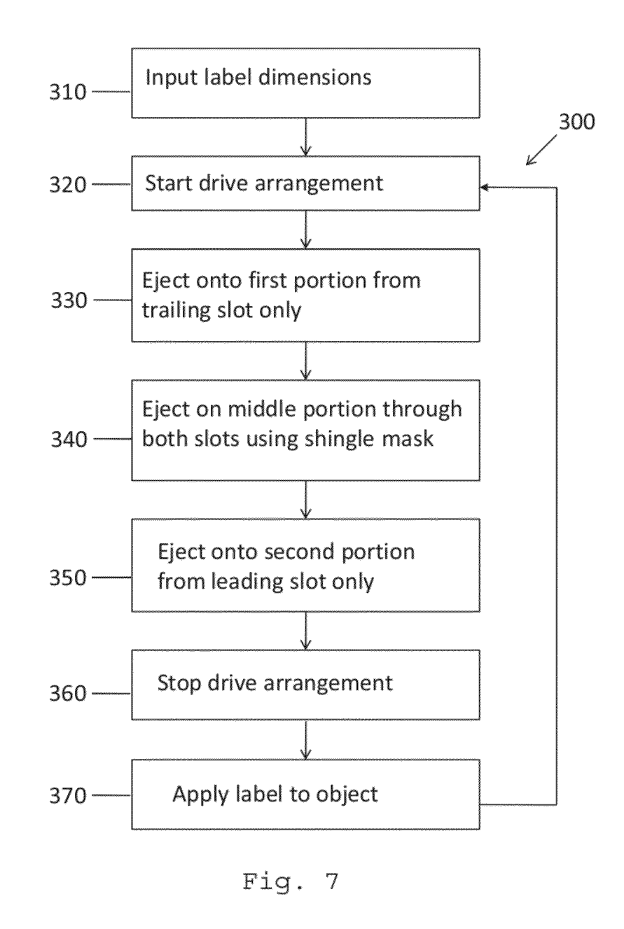

In an embodiment, a method 200 of label printing may be provided as diagrammatically illustrated in the flowchart of FIG. 6. The method 200 may use media, such as a label roll 160, comprising a number of labels and a printhead 1 comprising a leading and a trailing slot 5, 6. The method 200 may comprise starting a movement of the media with respect to the printhead 1 until the media reaches a certain continuous velocity with respect to the printhead 1 as indicated by block 210 and FIG. 2.

The method 200 may comprise ejecting fluid onto a label 4 near a first edge 7 of the label 4 from the trailing slot 6 and not from the leading slot 5, as indicated by block 220 and FIG. 3. In an embodiment, the method 200 may include ejecting fluid from both slots 5, 6 onto a middle portion 9, at a continuous speed, as indicated by block 230 and FIG. 4. The method 200 may further include ejecting fluid onto the label 4 near a second edge 10 of the label 4, opposite said first edge 7, from the leading slot 5 and not from the trailing slot 6, as indicated by block 240 and FIG. 5.

The method 200 may include stopping the movement of the printhead 1 with respect to the label 4, as indicated by block 250. The method 200 may further include applying the printed label 4 to the object 120, as indicated by block 260. The method 200 may reinitiate the startup process, as indicated by block 210, for printing a next label 4. In another embodiment, the method 200 may comprise printing sequential labels 4 without stopping the movement.

As shown in FIG. 7, the computer readable medium 140 may comprise a set of instructions 300 for enacting the method of label printing 200. The processing circuit 130 may signal the various respective components of the label print arrangement 100 according to those instructions.

In an embodiment, as indicated by block 310, the instructions may be configured to retrieve or receive label dimension data from the computer readable medium 140. The label dimension data may include distances D between labels 4, dimensions of the first portion 8, dimensions of the middle portion 9 and/or dimensions of the second portion 11.

The instructions may be configured to signal the drive arrangement 150 to start a movement of the media with respect to the printhead 1 so that the media reaches a predetermined approximately continuous velocity with respect to the printhead 1, as indicated by block 320.

The instructions may be configured to signal the printhead 1 to eject fluid onto the first portion 8 near the first edge 7 of a label from the trailing slot 6 and not from the leading slot 5, as indicated by block 330. The instructions may be configured so that printing may be started before or after the continuous velocity is reached. The instruction 330 may be configured to start printing from the trailing slot 6 when or after the trailing slot 6 passes the first edge 7. The location of the first edge 7 with respect to the trailing slot 6 may be determined by the input label dimension data or for example by an optical sensor.

As indicated by block 340, the instructions may comprise a shingle mask algorithm configured to distribute the fluid to both slots 5, 6 to print a predetermined pattern onto the middle portion 9. The borders of the middle portion 9 and the second portion 11 may be detected and/or determined with the aid of a sensor and/or the label dimension data, respectively.

As indicated by block 350, the instructions may further be configured to signal the printhead 1 to eject fluid onto the second portion 11, i.e. the label portion between the middle portion 9 and the second edge 10 opposite the first edge 7, from the leading slot 5 and not from the trailing slot 6.

The instructions may be configured to signal the print head 1 to stop printing, approximately when the leading slot 5 passes the second edge 10. The instructions may be configured to stop the drive arrangement 150, after the leading slot 5 has passed the second edge 10 and/or has stopped printing, as indicated by block 360. The instructions may further be configured to signal the label applicator 110 to apply the printed label 4 to the object 120, as indicated by block 370. The instructions may further be configured to reinitiate the drive arrangement 150, at block 320, to reinitiate the label printing method 200 for a subsequent label 4. For example, the method 200 and instruction set 300 may repeat itself up to a maximum or predetermined number of printed labels 4 or an interfering action by a user.

In a first aspect, a method 200 of label printing may be provided, using media comprising a number of labels 4 and a printhead 1 comprising a leading and a trailing slot 5, 6, comprising (i) starting a movement of the media with respect to the printhead 1 until the media reaches a certain continuous velocity with respect to the printhead, (ii) ejecting fluid onto a label 4 near a first edge 7 of a label 4 from the trailing slot 6 and not from the leading slot 5, and (iii) ejecting fluid onto the label 4 near a second edge 10 of the label 4, opposite said first edge 7, from the leading slot 5 and not from the trailing slot 6.

In a second aspect, a computer readable medium 140 may be provided, comprising instructions 300 stored thereon for enacting a method 200 of label printing, using media comprising a number of labels 4 and a printhead 1 comprising a leading and a trailing slot 5, 6, the instructions comprising (i) starting a movement of the media with respect to the printhead 1 until the media reaches a certain continuous velocity with respect to the printhead 1, (ii) ejecting fluid onto a label portion 8 near a first edge 7 of a label 4 from the trailing slot 6 and not from the leading slot 5, and (iii) ejecting fluid onto a label portion 11 near a second edge 10 of the label 4 opposite said first edge 7 from the leading slot 5 and not from the trailing slot 6.

In a third aspect, a label print arrangement 100 may be provided, comprising a printhead 1 provided with a leading and a trailing slot 5, 6 for ejecting fluid, and a label roll drive arrangement 150 arranged to start and stop the movement of a label roll 160 for moving a label 4 with respect to the printhead 1.

The above description is not intended to be exhaustive or to limit the invention to the embodiments disclosed. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, while a reference to a certain number of elements does not exclude the possibility of having more elements. A single unit may fulfil the functions of several items recited in the disclosure, and vice versa several items may fulfil the function of one unit.

The mere fact that certain measures are recited in mutually different dependent claims does not indicate that a combination of these measures cannot be used to advantage. Multiple alternatives, equivalents, variations and combinations may be made without departing from the scope of the invention.

What is claimed is:

1. Method of label printing, using media comprising a number of labels and a printhead comprising a leading and a trailing slot, comprising
starting a movement of the media with respect to the printhead until the media reaches a certain continuous velocity with respect to the printhead,
ejecting fluid onto a lab& near a first edge of a label from the trailing slot and not from the leading slot, and
ejecting fluid onto the label near a second edge of the label, opposite said first edge, from the leading slot and not from the trailing slot.

2. Method according to claim 1, comprising ejecting fluid onto a middle portion of the label by both the leading and the trailing slot.

3. Method according to claim 1, wherein the media moves at a continuous velocity with respect to the printhead when the middle portion of the label is printed.

4. Method according to claim 1, wherein the media comprises a label roll having spaces between labels of at least approximately 0.05 inch.

5. Method according to claim 1, wherein the media reaches said continuous velocity in approximately 0.8 inch or less.

6. Method according to claim 1, comprising printing multiple labels, wherein between the printing of a first label and a second label the first label is applied to an object.

7. Method according to claim 1, comprising printing the middle portion using shingle mask instructions for distributing the fluid through said leading and trailing slot.

8. Method according to claim 1, wherein the fluid ejected by the leading and the trailing slot comprises the same colored fluid.

9. Computer readable medium, comprising instructions stored thereon for enacting a method of label printing, using media comprising a number of labels and a printhead comprising a leading and a trailing slot, the instructions comprising
starting a movement of the media with respect to the printhead until the media reaches a certain continuous velocity with respect to the printhead,
ejecting fluid onto a label portion near a first edge of a label from the trailing slot and not from the leading slot, and
ejecting fluid onto a label portion near a second edge of the label opposite said first edge from the leading slot and not from the trailing slot.

10. Label print arrangement, comprising
a printhead provided with a leading and a trailing slot for ejecting fluid, and
a label roll drive arrangement arranged to start and stop the movement of a label roll for moving a label with respect to the printhead.

11. Label print arrangement according to claim 10, wherein the label roll drive arrangement is configured to drive the label roll in one direction.

12. Label print arrangement according to claim 10, comprising a storage arrangement and a processing circuit for storing and executing, respectively, shingle mask instructions for distributing the fluid to said leading and trailing slot.

13. Label print arrangement according to claim 10, wherein the printhead is arranged to print in one color only.

14. Label print arrangement according to claim 10, wherein the distance between the slots is at least approximately 0.05 inch.

15. Label print arrangement according to claim 10, comprising a label applicator arranged to apply a printed label to an object.
